(19) United States
(12) Patent Application Publication
(10) Pub. No.: US 2011/0252970 A1
(43) Pub. Date: Oct. 20, 2011

(54) Filtration Media for High Humidity Environments

(75) Inventors: David Charles Jones, Midlothian, VA (US); Junaid Ahmed Siddiqui, Richmond, VA (US)

(73) Assignee: E. I. DU PONT DE NEMOURS AND COMPANY, WILMINGTON, DE (US)

(21) Appl. No.: 12/904,226

(22) Filed: Oct. 14, 2010

Related U.S. Application Data
(60) Provisional application No. 61/262,738, filed on Nov. 19, 2009.

(51) Int. Cl. B01D 39/16; B01D 46/00; B01D 39/20; B32B 5/02

(52) U.S. Cl. 95/273; 428/372; 55/524; 55/490

(57) ABSTRACT

The invention is directed to a nanofiber that contains at least one moisture sensitive polymer. The fiber also contains nanoparticles of a hydrogen bonding material incorporated into the body of the fiber. The hydrogen bonding material is present in an amount corresponding to greater than 2% of the polymer weight and the nanofiber has a mean fiber diameter measured along its length of less than one micron. Also included are filter media made from nanowebs of the fiber.

### FIELD OF THE INVENTION

This invention relates to the field of filtration, and in particular improved methods and materials for filtering air and other gas streams.

### BACKGROUND

Fluid streams such as air and gas streams often carry particulate material therein. The removal of some or all of the particulate material from the fluid stream is needed. For example, air intake streams to the cabins of motorized vehicles, air in computer disk drives, HVAC air, clean room ventilation and applications using filter bags, barrier fabrics, woven materials, air to engines for motorized vehicles, or to power generation equipment; gas streams directed to gas turbines; and, air streams to various combustion furnaces, often include particulate material therein. In the case of cabin air filters it is desirable to remove the particulate matter for comfort of the passengers and/or for aesthetics. With respect to air and gas intake streams to engines, gas turbines and combustion furnaces, it is desirable to remove the particulate material because particulate can cause substantial damage to the internal workings to the various mechanisms involved. In other instances, production gases or off gases from industrial processes or engines may contain particulate material therein. Before such gases can be, or should be, discharged through various downstream equipment to the atmosphere, it may be desirable to obtain a substantial removal of particulate material from those streams.

As more demanding applications are envisioned for filtration media made of polymeric materials, significantly improved materials are required to withstand the rigors of temperatures above ambient and in particular high humidity or in the presence of liquid water. Polymeric materials can degrade or undergo morphological changes in the presence of heat and/or moisture, and filtration efficiency or pressure drops can be affected. In cases where the pressure drop is raised in the presence of moisture, either the lifetime of the filter is reduced or the cost of driving air or gas through the filter is raised.

One important parameter of the filter elements after formation is therefore its resistance to the effects of heat, humidity or both. One practical example regarding of the need for a filter to be able to manage moisture is with Gas Turbine intake filters where turbines are operated near coastal areas or in rain or fog conditions. Moisture can become entrained in the filter element causing an increase in pressure drop which reduces the power output of the turbine. The ability for a filter media to be unaffected by moisture would be valuable to a turbine operator and allow the turbine to produce power without any losses due to suction resistance increases.

The present invention addresses a need for polymeric materials, micro- and nanofiber materials and filter structures that provide improved properties for filtering streams with higher temperatures and higher humidity. In particular the present invention is directed to filter structures that do not exhibit pressure fluctuations in the presence of humidity.

### SUMMARY OF THE INVENTION

The present invention is directed to a nanofiber comprising at least one moisture sensitive polymer and essentially spherical nanoparticles of a hydrogen bonding material incorporated into the body of the fiber, wherein the material is present in an amount corresponding to greater than 2% of the polymer weight and the nanofiber has a mean fiber diameter measured along its length of less than one micron.

The invention is further directed to a filter media comprising a nanoweb, said nanoweb comprising moisture sensitive polymeric nanofibers of a number average fiber diameter of one micron or less, said fibers incorporating essentially spherical nanoparticles of a hydrogen bonding material, wherein the hydrogen bonding material is present in an amount corresponding to greater than 2% of the polymer weight and the nanofiber has a mean fiber diameter measured along its length of less than one micron.

The invention is further directed to a process for filtering air comprising the step of passing the air through a media, said media comprising a nanoweb as described above, said nanoweb comprising moisture sensitive polymeric fibers of a number average fiber diameter of one micron or less, and comprising nanoparticles of a hydrogen bonding material, wherein the material is present in an amount corresponding to greater than 2% of the polymer weight and the nanofiber has a mean fiber diameter measured along its length of less than one micron. In one embodiment of the process the nanoparticles are essentially spherical.

### DETAILED DESCRIPTION OF THE INVENTION

The present invention is directed to a nanofiber comprising at least one moisture sensitive polymer and nanoparticles of a hydrogen bonding material incorporated into the body of the fiber, wherein the material is present in an amount corresponding to greater than 2% of the polymer weight and the nanofiber has a mean fiber diameter measured along its length of less than one micron. Preferably the nanoparticles are essentially spherical.

The moisture sensitive polymer is not particularly limited but can be selected from the group consisting of polyacetal, polyamide, polyester, cellulose ether and ester, polyalkylene sulfide, polyarylene oxide, polysulfone, modified polysulfone polymer and mixtures thereof. Also, poly(vinylchloride), polymethylmethacrylate (and other acrylic resins), polyvinylalcohol in various degrees of hydrolysis (87% to 99.5%) in crosslinked and non-crosslinked forms.

The hydrogen bonding material is also not particularly limited but can be selected from the group consisting of silica, alumina, zirconia, and an organic polymer.

The hydrogen bonding material may also be present in an amount corresponding to greater than 2.5% of the polymer weight, preferably greater than 3% of the polymer weight and even greater than 4% or 5% of the polymer weight.

The invention is further directed to a filter media comprising a nanoweb, said nanoweb comprising moisture sensitive polymeric nanofibers of a number average fiber diameter of one micron or less, said fibers incorporating nanoparticles of a hydrogen bonding material as described above and present in an amount corresponding to greater than 2%, or 2.5% of the polymer weight, preferably greater than 3% of the polymer weight and even greater than 4% or 5% of the polymer weight.

The invention is also directed to a filter assembly comprising the filter media as described above.

The invention is further directed to a process for filtering air comprising the step of passing the air through a media, said media comprising a nanoweb as described above, said nanoweb comprising moisture sensitive polymeric fibers of a number average fiber diameter of one micron or less, and comprising nanoparticles of a hydrogen bonding material and present in an amount corresponding to greater than 2%, or even 2.5% of the polymer weight, preferably greater than 3% of the polymer weight and even greater than 4% or 5% of the polymer weight. In one embodiment of the process the nanoparticles are essentially spherical.

### DEFINITIONS

A “suspension” or “sol” can refer to any slurry, suspension or emulsion of particles of any shape or size in a fluid. Normally the fluid is water, although the invention is not limited to aqueous suspensions. The suspension may refer to a system that is unstable with respect to settling over time but is dispersed for the period of use in the invention.

As used herein, “fiber” denotes an elongate body, the length dimension of which is much greater than the transverse dimensions of width and thickness. Accordingly, “fiber” includes, for example, monofilament, multifilament yarn (continuous or staple), ribbon, strip, staple and other forms of chopped, cut or discontinuous fiber, and the like having regular or irregular cross-sections. “Fiber” includes a plurality of any one of the above or a combination of the above.

“Nanoparticles” as used in this invention mean particles made substantially of either an inorganic or organic material, with a major (longest) dimension of less than about 750 nm and preferably less than 500 nm, more preferably less than 200 or even 100 nm. The nanoparticles of the invention are capable of hydrogen bonding to the polymer into which they are incorporated. By the term “hydrogen bonding” is meant the kind of intermolecular bonding that would be understood by one skilled in the art, and in particular the chemical arts. In the context of the present invention, polar groups on the polymer such as amine, amide and carboxylic linkages, are capable of being bonded electrostatically to polar linkages on the material. When the material is inorganic, such polar linkages on the material will typically be metal-oxygen bonds such as Si—O, Al—O, Zr—O, Ti—O, and the like.

By “essentially spherical” is meant that the particles have spherical symmetry to within the precision allowed by their method of manufacture, and no one axis or direction of the particle could be judged to be significantly larger than any other. Neither is any one axis preferred in the orientation of the particle in the polymer fiber matrix. Distortions from spherical symmetry that occur as a result of the method of manufacture or observation of the particle still render the particle spherically symmetric in the terms of this invention.

Nanoparticulate materials suitable for use on this invention include but are not limited to silica, alumina, zirconia, titania, and hybrid materials, or organic polymers that form nanoparticulate structures when incorporated into the polymer matrix. Kaolin clay may be used in this invention and may be either hydrous (Al₂O₃.2SiO₂.2H₂O) or calcined (Al₂O₃.2SiO₂). Hydrous and calcined kaolin clay are well known, commercially available materials.

The nanoparticles may be incorporated into the polyamide fiber by a variety of techniques. For example, the nanoparticles can be mixed with the monomer(s) that forms the polymer prior to polymerization or it can be mixed with a nonvolatile oil to form a pourable slurry which is then added to the polymer. The further method is by a masterbatch technique wherein a concentrate that contains polyamide and the kaolin clay is blended or letdown into a feed or base polyamide resin. The blend is then spun into fiber. The concentrate can be injected into a spinning machine that includes the base polymer resin. The concentrate could include about 9 to about 50, preferably about 25 to about 35, weight percent of the nanoparticulate material, based on the weight of the concentrate, with the remainder being polymer.

The amount of nanoparticulate in the fiber should be greater than about 2.0, preferably greater than 2.5, 3.0, 4.0 or even 5.0 weight percent, based on the weight of the polymer fiber. If less than 2 weight percent is included, the polymer fiber will not exhibit the desired moisture resistance.

“Calendering” is the process of passing a web through a nip between two rolls. The rolls may be in contact with each other, or there may be a fixed or variable gap between the roll surfaces. Advantageously, in the present calendering process, the nip is formed between a soft roll and a hard roll. The “soft roll” is a roll that deforms under the pressure applied to keep two rolls in a calendar together. The “hard roll” is a roll with a surface in which no deformation that has a significant effect on the process or product occurs under the pressure of the process. An “unpatterned” roll is one which has a smooth surface within the capability of the process used to manufacture them. There are no points or patterns to deliberately produce a pattern on the web as it passed through the nip, unlike a point bonding roll.

A “scrim” is a support layer and can be any structure with which the nanoweb can be bonded, adhered or laminated. Advantageously, the scrim layers useful in the present invention are spunbond nonwoven layers, but can be made from carded webs of nonwoven fibers and the like. Scrim layers useful for some filter applications require sufficient stiffness to hold pleats and dead folds

The term “nonwoven” means a web including a multitude of fibers. The fibers can be bonded to each other or can be unbonded. The fibers can be staple fibers or continuous fibers. The fibers can comprise a single material or a multitude of materials, either as a combination of different fibers or as a combination of similar fibers each comprised of different materials.

A nonwoven fibrous web useful in embodiments of the invention comprises moisture sensitive fibers of materials such as, for example, elastomers, polyesters, rayon, cellulose, nylon, and blends of such fibers. A number of definitions have been proposed for nonwoven fibrous webs. The fibers usually include staple fibers or continuous filaments. As used herein “nonwoven fibrous web” is used in its generic sense to define a generally planar structure that is relatively flat, flexible and porous, and is composed of staple fibers or continuous filaments. For a detailed description of nonwovens, see “Nonwoven Fabric Primer and Reference Sampler” by E. A. Vaughn, ASSOCIATION OF THE NONWOVEN FABRICS INDUSTRY, 3d Edition (1992). The nonwovens may be carded, spun bonded, wet laid, air laid and melt blown as such products are well known in the trade.

Examples of nonwoven fabrics include meltblown webs, spunbond webs, carded webs, air-laid webs, wet-laid webs, spunlaced webs, and composite webs comprising more than one nonwoven layer.

The term “nanofibers” as used herein refers to fibers having a number average diameter less than about 1000 nm, even less than about 800 nm, even between about 50 nm and 500 nm, and even between about 100 and 400 nm. In the case of non-round cross-sectional nanofibers, the term “diameter” as used herein refers to the greatest cross-sectional dimension.

“A web comprising moisture sensitive polymeric fibers” means a web comprising fibers made of a polymer that exhibits a pressure spike in the presence of moisture, either in liquid droplet form or in the form of a humid air or gas stream, when the web is used as a filter medium in a gas such as air. Such polymers will normally have in the backbone of the polymer chain or in the end group thereof, at least one polar covalent bond between two dissimilar elements.

Examples of moisture sensitive polymeric materials that can be used in the polymeric compositions of the invention include both addition polymer and condensation polymer materials such as, but not limited to, polyacetal, polyamide, polyester, cellulose ether and ester, polyalkylene sulfide, polyarylene oxide, polysulfone, modified polysulfone polymers and mixtures thereof. Preferred materials that fall within these generic classes include poly(vinylchloride), polymethylmethacrylate (and other acrylic resins), polyvinylalcohol in various degrees of hydrolysis (87% to 99.5%) in crosslinked and non-crosslinked forms. Preferred addition polymers may be glassy (a Tg greater than room temperature) such as is the case for polyvinylchloride and polymethylmethacrylate, and polyvinylalcohol materials, and may incorporate a plasticizer.

One class of polyamide condensation polymers useful in the invention are nylon materials. The term “nylon” is a generic name for all long chain synthetic polyamides. Typically, nylon nomenclature includes a series of numbers such as in nylon-6,6 which indicates that the starting materials are a C₆ diamine and a C₆ diacid (the first digit indicating a C₆ diamine and the second digit indicating a C₆ dicarboxylic acid compound). Nylon can also be made by the polycondensation of ε caprolactam in the presence of a small amount of water. This reaction forms a nylon-6 (made from a cyclic lactam—also known as c-aminocaproic acid) that is a linear polyamide. Further, nylon copolymers are also contemplated. Copolymers can be made by combining various diamine compounds, various diacid compounds and various cyclic lactam structures in a reaction mixture and then forming the nylon with randomly positioned monomeric materials in a polyamide structure. For example, a nylon 6,6-6,10 material is a nylon manufactured from hexamethylene diamine and a C₆ and a C₁₀ blend of diacids. A nylon 6-6, 6-6,10 is a nylon manufactured by copolymerization of epsilonaminocaproic acid, hexamethylene diamine and a blend of a C₆ and a C₁₀ diacid material.

Block copolymers are also useful in the product and process of this invention. With such copolymers the choice of solvent swelling agent is important. The selected solvent is such that both blocks were soluble in the solvent. Examples of such block copolymers are Pebax®. type of e-caprolactam-b-ethylene oxide, Sympatex® polyester-b-ethylene oxide and polyurethanes of ethylene oxide and isocyanates.

Addition polymers like polyvinyl alcohol, polyvinyl acetate, amorphous addition polymers, such as poly(acrylonitrile) and its copolymers with acrylic acid and methacrylates, polystyrene, poly(vinyl chloride) and its various copolymers, poly(methyl methacrylate) and its various copolymers, are suitable for use in the invention and can be solution spun with relative ease because they are soluble at low pressures and temperatures.

There may be an advantage to forming polymeric compositions comprising two or more polymeric materials in polymer admixture, alloy format or in a crosslinked chemically bonded structure. Such polymer compositions improve physical properties by changing polymer attributes such as improving polymer chain flexibility or chain mobility, increasing overall molecular weight and providing reinforcement through the formation of networks of polymeric materials.

In one embodiment of this concept, two related polymer materials can be blended for beneficial properties. For example, a high molecular weight polyvinylchloride can be blended with a low molecular weight polyvinylchloride. Similarly, a high molecular weight nylon material can be blended with a low molecular weight nylon material. Further, differing species of a general polymeric genus can be blended. For example, a Nylon-6 material can be blended with a nylon copolymer such as a Nylon-6; 6,6; 6,10 copolymer. Further, a polyvinylalcohol having a low degree of hydrolysis such as a 87% hydrolyzed polyvinylalcohol can be blended with a fully or superhydrolyzed polyvinylalcohol having a degree of hydrolysis between 98 and 99.9% and higher. All of these materials in admixture can be crosslinked using appropriate crosslinking mechanisms. Nylons can be crosslinked using crosslinking agents that are reactive with the nitrogen atom in the amide linkage. Polyvinylalcohol materials can be crosslinked using hydroxyl reactive materials such as monoaldehydes, such as formaldehyde, ureas, melamine-formaldehyde resin and its analogues, boric acids and other inorganic compounds. dialdehydes, diacids, urethanes, epoxies and other known crosslinking agents. Crosslinking technology is a well known and understood phenomenon in which a crosslinking reagent reacts and forms covalent bonds between polymer chains to substantially improve molecular weight, chemical resistance, overall strength and resistance to mechanical degradation.

It should be understood that an extremely wide variety of fibrous filter media exist for different applications. The durable nanofibers and microfibers described in this invention can be added to any of the media. The fibers described in this invention can also be used to substitute for fiber components of these existing media giving the significant advantage of improved performance (improved efficiency and/or reduced pressure drop) due to their small diameter, while exhibiting greater durability.

The as-spun nanoweb of the present invention can be calendered in order to impart the desired improvements in physical properties. In one embodiment of the invention the as-spun nanoweb is fed into the nip between two unpatterned rolls in which one roll is an unpatterned soft roll and one roll is an unpatterned hard roll, and the temperature of the hard roll is maintained at a temperature that is between the T_{g}, herein defined as the temperature at which the polymer undergoes a transition from glassy to rubbery state, and the Tₒₘ, herein defined as the temperature of the onset of melting of the polymer, such that the nanofibers of the nanoweb are at a plasticized state when passing through the calendar nip. The composition and hardness of the rolls can be varied to yield the desire end use properties. In one embodiment of the invention, one roll is a hard metal, such as stainless steel, and the other a soft-metal or polymer-coated roll or a composite roll having a hardness less than Rockwell B 70. The residence time of the web in the nip between the two rolls is controlled by the line speed of the web, preferably between about 1 m/min and about 50 m/min, and the footprint between the two rolls is the MD distance that the web travels in contact with both rolls simultaneously. The footprint is controlled by the pressure exerted at the nip between the two rolls and is measured generally in force per linear CD dimension of roll, and is preferably between about 1 mm and about 30 mm.

Further, the nonwoven web can be stretched, optionally while being heated to a temperature that is between the T_{g} and the lowest Tₒₘ of the nanofiber polymer. The stretching can take place either before and/or after the web is fed to the calendar rolls, and in either or both of the MD or CD.

The terms “nanoparticles” can also include “nanoclays”, and “organoclays”. By “nanoparticles”, is meant particles with a largest dimension (e.g., a diameter) of less than, or less than or equal to about 750 nm (nanometers). Also incorporated and included herein, as if expressly written herein, are all ranges of particle sizes that are between 0 nm and 750 nm. It should be understood that every limit given throughout this specification will include every lower, or higher limit, as the case may be, as if such lower or higher limit was expressly written herein. Non-limiting examples of particle size distributions of the nanoparticles are those that fall within the range from about 2 nm to less than about 750 nm, alternatively from about 2 nm to less than about 200 nm, and alternatively from about 2 nm to less than about 150 nm. It should also be understood that certain ranges of particle sizes may be useful depending on the size of the fiber into which the nanoparticles are incorporated. The mean particle size of various types of particles may differ from the particle size distribution of the particles. For example, a layered synthetic silicate can have a mean particle size of about 25 nanometers while its particle size distribution can generally vary between about 10 nm to about 40 nm. (It should be understood that the particle sizes that are described herein are for particles when they are dispersed in an aqueous medium and the mean particle size is based on the mean of the particle number distribution.

Spherical particles are preferred in the invention, but nanoparticles can include non spherical particles. Non-limiting examples of nanoparticles can include crystalline or amorphous particles with a particle size from about 2 to about 750 nanometers. For example boehmite alumina can have an average particle size distribution from 2 to 750 nm. Nanotubes can include structures up to 1 centimeter long, alternatively with a particle diameter from about 2 to about 50 nanometers.

Nanoparticles suitable for use in the compositions of the invention may be substantially spherical in shape, and have an average particle diameter less than about 750 nanometers and are substantially inorganic in chemical composition. The nanoparticles can comprise essentially a single oxide such as silica or can comprise a core of an oxide of one type (or a core of a material other than a metal oxide) on which is deposited an oxide of another type. Generally, the nanoparticles can also range in size (mean particle diameter) from about 2 nanometers to about 750 nanometers, from about 2 nanometers to about 500 nanometers, from about 10 nanometers to about 300 nanometers, or from about 10 nanometers to about 100 nanometers, and can range in size in any range between 5 and 500 nanometers. It is also desirable that the nanoparticles have a relatively narrow particle size distribution around a given mean particle size.

Some layered clay minerals and inorganic metal oxides can be examples of nanoparticles, and are also referred to herein as “nanoclays”. The layered clay minerals suitable for use in the present invention include those in the geological classes of the smectites, the kaolins, the illites, the chlorites, the attapulgites and the mixed layer clays. Typical examples of specific clays belonging to these classes are the smectices, kaolins, illites, chlorites, attapulgites and mixed layer clays. Smectites, for example, include montmorillonite, bentonite, pyrophyllite, hectorite, saponite, sauconite, nontronite, talc, beidellite, volchonskoite and vermiculite. Kaolins include kaolinite, dickite, nacrite, antigorite, anauxite, halloysite, indellite and chrysotile. Illites include bravaisite, muscovite, paragonite, phlogopite and biotite. Chlorites include corrensite, penninite, donbassite, sudoite, pennine and clinochlore. Attapulgites include sepiolite and polygorskyte. Mixed layer clays include allevardite and vermiculitebiotite. Variants and isomorphic substitutions of these layered clay minerals offer unique applications.

Layered clay minerals may be either naturally occurring or synthetic. An example of one non-limiting embodiment of the nanoclay particle used herein uses natural or synthetic hectorites, montmorillonites and bentonites. Another embodiment uses the hectorites clays commercially available, and typical sources of commercial hectorites are the LAPONITEs®. from Southern Clay Products, Inc., U.S.A; Veegum Pro and Veegum F from R. T. Vanderbilt, U.S.A.; and the Barasyms, Macaloids and Propaloids from Baroid Division, National Read Comp., U.S.A.

Natural clay minerals typically exist as layered silicate minerals and less frequently as amorphous minerals. A layered silicate mineral has SiO₄ tetrahedral sheets arranged into a two-dimensional network structure. A 2:1 type layered silicate mineral has a laminated structure of several to several tens of silicate sheets having a three layered structure in which a magnesium octahedral sheet or an aluminum octahedral sheet is sandwiched between two sheets of silica tetrahedral sheets. In some embodiments, it may be desirable for the nanofiber composition to comprise a plurality of nanoparticles that comprise types of (or a first group of) nanoparticles other than 2:1 layered silicates. It should be understood that such a group of nanoparticles refers to the type of nanoparticles, and such nanoparticles may be distributed throughout the nanofiber composition in any manner, and need not be grouped together. Also, even in these embodiments, the nanofiber composition may comprise at least some (possibly a non-functional amount) of nanoparticles comprising 2:1 layered silicates (which may comprise a second group of nanoparticles).

For incorporation of nanoparticles directly into fibers via a melt spinning process, masterbatches of the nanocomposite composition containing relatively high concentrations of exfoliated clay may be made and used. For example a nanocomposite composition masterbatch containing 30% by weight of exfoliated clay may be used. If a composition having 3 weight percent of the exfoliated clay is needed, the composition containing the 3 weight percent may be made by mixing 1 part by weight of the 30% masterbatch with 9 parts by weight of the “pure” polyamide. The mixing can be accomplished in the polymer melt by means of extrusion processing or alternatively by co-dissolving the masterbatch and the “pure” polyamide in a common solvent.

Such masterbatch compositions can be made by typical melt mixing techniques. For instance the ingredients may be added to a single or twin screw extruder or a kneader and mixed in the normal manner. After the materials are mixed they may be formed (cut) into pellets or other particles for convenient handling. Smectic clay (e.g., a montmorillonite) can best be dispersed homogeneously and exfoliated as individual platelets throughout a polymer matrix if it is made more compatible with the polymer. This can be accomplished by cation exchange of sodium in montmorillonite clay with alkyl ammonium ions more compatible with the polymer, or by chemical modification of the polymer, for example by grafting, to render it more compatible with the clay.

It is necessary to apply adequate shear stress to the polymer/clay mixture to separate the layers of the clay and subsequently to distribute the thus exfoliated clay platelets uniformly in the melt. Extruder screws should be designed to apply high shear stresses and some degree of axial mixing.

For incorporation of the nanoparticles directly into the fiber by a solution spinning process, the nanoparticles can be incorporated directly into the polymer solution prior to spinning. In that case, the nanoparticles form a suspension or colloid in the solution. Surfactant may optionally be added to ensure proper dispersion of nanoparticles into the solution. Heat and shear may need to be applied to the solution in order to achieve sufficient dispersion of particles, and one skilled in the art will be able to recognize processes and apparatus that would accomplish this task.

The as-spun nanoweb comprises primarily or exclusively nanofibers, advantageously produced by electrospinning, such as classical electrospinning or electroblowing, and in certain circumstances, by meltblowing or other such suitable processes. Classical electrospinning is a technique illustrated in U.S. Pat. No. 4,127,706, incorporated herein in its entirety, wherein a high voltage is applied to a polymer in solution to create nanofibers and nonwoven mats. However, total throughput in electrospinning processes is too low to be commercially viable in forming heavier basis weight webs.

The “electroblowing” process is disclosed in World Patent Publication No. WO 03/080905, incorporated herein by reference in its entirety. A stream of polymeric solution comprising a polymer and a solvent is fed from a storage tank to a series of spinning nozzles within a spinneret, to which a high voltage is applied and through which the polymeric solution is discharged. Meanwhile, compressed air that is optionally heated is issued from air nozzles disposed in the sides of, or at the periphery of the spinning nozzle. The air is directed generally downward as a blowing gas stream which envelopes and forwards the newly issued polymeric solution and aids in the formation of the fibrous web, which is collected on a grounded porous collection belt above a vacuum chamber. The electroblowing process permits formation of commercial sizes and quantities of nanowebs at basis weights in excess of about 1 gsm, even as high as about 40 gsm or greater, in a relatively short time period.

Nanowebs can also be produced for the invention by the process of centrifugal spinning. Centrifugal spinning is a fiber forming process comprising the steps of supplying a spinning solution or melt having at least one polymer optionally dissolved in at least one solvent to a rotary sprayer having a rotating conical nozzle, the nozzle having a concave inner surface and a forward surface discharge edge; issuing the spinning solution from the rotary sprayer along the concave inner surface so as to distribute said spinning solution toward the forward surface of the discharge edge of the nozzle; and forming separate fibrous streams from the spinning solution while the solvent vaporizes to produce polymeric fibers in the presence or absence of an electrical field. A shaping fluid can flow around the nozzle to direct the spinning solution away from the rotary sprayer. The fibers can be collected onto a collector to form a fibrous web. An example of a centrifugal spinning process is found in application Ser. Nos. 11/593,959 and 12/077,355 hereby incorporated in their entirety by reference.

A substrate or scrim can be arranged on the collector to collect and combine the nanofiber web spun on the substrate, so that the combined fiber web is used as a high-performance filter, wiper and so on. Examples of the substrate may include various nonwoven cloths, such as meltblown nonwoven cloth, needle-punched or spunlaced nonwoven cloth, woven cloth, knitted cloth, paper, and the like, and can be used without limitations so long as a nanofiber layer can be added on the substrate. The nonwoven cloth can comprise spunbond fibers, dry-laid or wet-laid fibers, cellulose fibers, melt blown fibers, glass fibers, or blends thereof.

A filter media construction according to the present invention may include a nanoweb alone, or a first layer of permeable coarse fibrous media or substrate having a first surface. A first layer of fine fiber media is secured to the first surface of the first layer of permeable coarse fibrous media. Preferably the first layer of permeable coarse fibrous material comprises fibers having an average diameter of at least 10 microns, typically and preferably about 12 (or 14) to 30 microns. Also preferably the first layer of permeable coarse fibrous material comprises a media having a basis weight of no greater than about 300 grams/meter², preferably about 70 to 270 g/m², and most preferably at least 15 g/m². Preferably the first layer of permeable coarse fibrous media is at least 0.0005 inch (12 microns) thick, and typically and preferably is about 0.001 to 0.030 inch (25-800 microns) thick.

Certain preferred arrangements according to the present invention include filter media as generally defined, in an overall filter construction. Some preferred arrangements for such use comprise the media arranged in a cylindrical, pleated configuration with the pleats extending generally longitudinally, i.e. in the same direction as a longitudinal axis of the cylindrical pattern. For such arrangements, the media may be imbedded in end caps, as with conventional filters. Such arrangements may include upstream liners and downstream liners if desired, for typical conventional purposes.

In some applications, media according to the present invention may be used in conjunction with other types of media, for example conventional media, to improve overall filtering performance or lifetime. For example, media according to the present invention may be laminated to conventional media, be utilized in stack arrangements; or be incorporated (an integral feature) into media structures including one or more regions of conventional media. It may be used upstream of such media, for good load; and/or, it may be used downstream from conventional media, as a high efficiency polishing filter.

According to the present invention, methods are provided for filtering. The methods generally involve utilization of media as described to advantage, for filtering. Media according to the present invention can be specifically configured and constructed by one skilled in the art of filter design to provide relatively long life in relatively efficient systems.

### EXAMPLES

### Moisture Test

Simulation of the wetting of a filter media and measuring the associated increase in air flow resistance involved using a 17.8 centimeter by 17.8 centimeter sample of media. The sample was secured and sealed over a pressure chamber opening of 161.3 square centimeters using ten heavy-duty clamps evenly spaced around the perimeter. An air line was then connected to a low pressure regulator and the airflow into the pressure chamber was controlled by three separate flow meters. With the capacity to measure approximately 0-100 liters per minute, the flow meters allowed the air to enter the pressure chamber. Three pressure gauges measuring between 0 and 1270 millimeters of water then displayed the pressure inside the chamber as the air flow set at 17.2 liters/minute tries to pass through a 5 inch by 5 inch square area of the media sample. This dry sample pressure measurement was recorded as the initial pressure. The face velocity generated by a flow rate of 17.2 Liters/minute was approximately 1.78 centimeters/second for the 161.3 square centimeter media area and corresponded to a typical face velocity found in operating gas turbine filters. The sample is subjected to a water mist spray from nozzles located inside the pressure chamber at a flow rate between 55 and 70 ml/min for a six minute period. At the onset of the water spray, pressure measurements were made every 30 seconds until the sample dried out and returns to approximately the initial dry starting pressure.

### Example 1

Using the moisture test procedure a control sample consisting of 165 g/m² spunbond Polyester manufactured by Kolon Industries, Inc. style L2165 faced with approximately 2 g/m² of Nylon 6,6 electroblown nanofibers was tested as a baseline performance data set. Subsequent moisture tests using the same protocol were conducted on samples processed with the same base materials and basis weights but also containing additives of silica nanoparticles manufactured by Nissan Chemicals in a 20.7% concentration by volume with Ethylene Glycol under the trade name EG-ST and cospun with the electroblown Nylon 6,6 nanofibers. Two weight concentrations of EG-ST were produced such that the approximate 2 g/m² of Nylon 6,6 contained approximately 3% and 5% by weight amorphous silica nanoparticles <100 nm in diameter. The results shown in Table 1. demonstrate the improvement related to the concentration of amorphous silica nanoparticles added vs. the control sample of 165 g/m² spunbond polyester and 2 g/m² of Nylon 6,6 nanofibers containing no amorphous silica nanoparticles. Also shown is the performance of just the 165 g/m² spunbond Polyester manufactured by Kolon Industries, Inc. style L2165 without the Nylon 6,6 nanofibers to isolate the pressure drop contribution of just the spunbond PET portion of the structure which was not subjected to the addition of the amorphous silica nanoparticles.

TABLE 1

| | | Time to Reach Max |
|---|---|---|
| | Max ΔP | ΔP |
| Sample | (mm H2O) | seconds |
| Base 165 g/m² | 135 | 180 |
| Spunbond PET | | |
| 165 g/m² Spunbond | 241 | 360 |
| PET with 2 g/m² Nylon | | |
| 6,6 Nanofibers | | |
| 165 g/m² Spunbond | 203 | 360 |
| PET with 2 g/m² Nylon | | |
| 6,6 Nanofibers | | |
| containing 3 wt. % | | |
| Amorphous Silica | | |
| nanoparticles | | |
| 165 g/m² Spunbond | 130 | 210 |
| PET with 2 g/m² Nylon | | |
| 6,6 Nanofibers | | |
| containing 5 wt. % | | |
| Amorphous Silica | | |
| nanoparticles | | |

### Example 2

Using the moisture test procedure a control sample consisting of 165 g/m² spunbond Polyester manufactured by Kolon Industries, Inc. style L2165 faced with approximately 2 g/m² of Nylon 6,6 electroblown nanofibers was tested as a baseline performance data set. Subsequent moisture tests using the same protocol were conducted on samples processed with the same base materials and basis weights but also containing additives of silica nanoparticles manufactured by Nissan Chemicals in a 30.5% concentration by volume with Methylene Chloride under the trade name MEK-ST and cospun the electroblown Nylon 6,6 nanofibers. Three weight concentrations of MEK-ST were produced such that the approximate 2 g/m² of Nylon 6,6 contained approximately 1% 3%, and 5% by weight amorphous silica nanoparticles <100 nm in diameter. The results shown in Table 2. demonstrate the improvement related to the concentration of amorphous silica nanoparticles added vs. the control sample of 165 g/m² spunbond polyester and 2 g/m2 of Nylon 6,6 nanofibers containing no amorphous silica nanoparticles. Also shown is the performance of just the 165 g/m² spunbond Polyester manufactured by Kolon Industries, Inc. style L2165 without the Nylon 6,6 nanofibers to isolate the pressure drop contribution of just the spunbond PET portion of the structure which was not subjected to the addition of the amorphous silica nanoparticles.

TABLE 2

| | | Time to Reach Max |
|---|---|---|
| | Max ΔP | ΔP |
| Sample | (mm H2O) | seconds |
| Base 165 g/m2 | 135 | 180 |
| Spunbond PET | | |
| 165 gsm Spunbond | 241 | 360 |
| PET with 2 gsm Nylon | | |
| 6,6 Nanofibers | | |
| 165 gsm Spunbond | 137 | 360 |
| PET containing 2 gsm | | |
| Nylon 6,6 Nanofibers | | |
| with 1 wt. % | | |
| Amorphous Silica | | |
| nanoparticles | | |
| 165 gsm Spunbond | 126 | 360 |
| PET containing 2 gsm | | |
| Nylon 6,6 Nanofibers | | |
| with 3 wt. % | | |
| Amorphous Silica | | |
| nanoparticles | | |
| 165 gsm Spunbond | 127 | 360 |
| PET containing 2 gsm | | |
| Nylon 6,6 Nanofibers | | |
| with 5 wt. % | | |
| Amorphous Silica | | |
| nanoparticles | | |

We claim:

1. A nanofiber comprising at least one moisture sensitive polymer and essentially spherical nanoparticles of a hydrogen bonding material incorporated into the body of the fiber, wherein the material is present in an amount corresponding to greater than 2% of the polymer weight and the nanofiber has a mean fiber diameter measured along its length of less than one micron.

2. The nanofiber of claim 1 in which the moisture sensitive polymer is selected from the group consisting of polyacetal, polyamide, polyester, cellulose ether, cellulose ester, polyalkylene sulfide, polyarylene oxide, polysulfone, modified polysulfone polymers and mixtures thereof, poly(vinylchloride), polymethylmethacrylate, and polyvinylalcohol in crosslinked and non-crosslinked forms.

3. The nanofiber of claim 1 in which the material is selected from the group consisting of silica, alumina, zirconia, and an organic polymer.

4. The nanofiber of claim 1 in which the material is present in an amount corresponding to greater than 2.5% of the polymer weight.

5. The nanofiber of claim 1 in which the material is present in an amount corresponding to greater than 3% of the polymer weight.

6. The nanofiber of claim 1 in which the material is present in an amount corresponding to greater than 4% of the polymer weight.

7. The nanofiber of claim 1 in which the material is present in an amount corresponding to greater than 5% of the polymer weight.

8. A filter media comprising a nanoweb, said nanoweb comprising moisture sensitive polymeric fibers of a number average fiber diameter of one micron or less, said fibers comprising essentially spherical nanoparticles of a hydrogen bonding material, wherein the material is present in an amount corresponding to greater than 2% of the polymer weight.

9. The media of claim 8 in which the moisture sensitive polymer is selected from the group consisting of polyacetal, polyamide, polyester, cellulose ether, cellulose ester, polyalkylene sulfide, polyarylene oxide, polysulfone, modified polysulfone polymers and mixtures thereof, poly(vinylchloride), polymethylmethacrylate, and polyvinylalcohol in crosslinked and non-crosslinked forms.

10. The media of claim 8 in which the material is selected from the group consisting of silica, alumina, zirconia, and an organic polymer.

11. The media of claim 8 in which the material is present in an amount corresponding to greater than 2.5% of the polymer weight.

12. The media of claim 8 in which the material is present in an amount corresponding to greater than 3% of the polymer weight.

13. The media of claim 8 in which the material is present in an amount corresponding to greater than 4% of the polymer weight.

14. The media of claim 8 in which the material is present in an amount corresponding to greater than 5% of the polymer weight.

15. A process for filtering air comprising the step of passing the air through a media, said media comprising a nanoweb, said nanoweb comprising moisture sensitive polymeric fibers of a number average fiber diameter of one micron or less, said fibers comprising nanoparticles of a hydrogen bonding material incorporated into the body of the fiber, wherein the material is present in an amount corresponding to greater than 2% of the polymer weight.

16. The process of claim 15 in which the polymer and the material are selected such that in the presence of the nanoparticles the media exhibits a pressure spike of less than 220 mm of water in the presence of 55-70 ml/min water flow rate over a surface area of 161.3 square centimeters in conjunction with an air flow face velocity of 1.78 cm/s and in which the pressure spike would exceed 240 mm of water in the absence of the nanoparticles.

17. The process of claim 15 in which the nanoparticles are essentially spherical.

18. The process of claim 16 in which the nanoparticles are essentially spherical.

19. A filter assembly comprising the filter media of claim 8.
